(19) United States
(12) Patent Application Publication
(10) Pub. No.: US 2004/0255974 A1
(43) Pub. Date: Dec. 23, 2004

(54) Equipment cleaner

(76) Inventor: Jeffrey P. Burress, Bristow, VA (US)

Correspondence Address: FISH & RICHARDSON P.C., 1425 K STREET, N.W., 11TH FLOOR, WASHINGTON, DC, 20005-3500, US

(21) Appl. No.: 10/601,196

(22) Filed: Jun. 23, 2003

(51) Int. Cl. B08B 3/00

(52) U.S. Cl. 134/2; 134/26; 134/28; 134/29

(57) ABSTRACT

A method of cleaning resist residue includes oxidizing the residue. The oxidized residue can be water soluble.

### TECHNICAL FIELD

This invention relates to compositions for printed circuit board manufacturing and methods for using the compositions.

### BACKGROUND

A multilayer printed circuit board is constructed by first defining the internal layers of the board. This is commonly referred to as the inner-layer process. The internal layers or cores as they are referred to may be a signal or ground layer depending on the design of the circuit. Each core or layer is composed of a dielectric, an epoxy/glass reinforced system that is bonded to a copper foil surface. The overall thickness of the core varies depending on the copper foil as well as the dielectric used. Copper foil thickness can vary in general from 0.25 oz to 2.0 oz depending on the application.

The copper foil is bonded to a prepreg (epoxy/glass) that is usually categorized by the glass style used in the construction. Typical examples are 2116, 2113, 106 and 1080. They vary in glass thickness and the bundle count within the weave. The resin incorporated within the glass can vary depending on the design of the circuit and the requirements. Examples for reference are FR-4 epoxy, polyimide, cyanate ester, and BT.

Once the cores are selected for processing they are chemically cleaned to remove any residue that may remain on the copper surface. The purpose of the precleaning is to provide surface cleanliness and topography for maximum adhesion of the photoresist. The precleaner may consist of a cleaner and microetch or a stand alone cleaner. Examples of cleaners include Shipley's Preposit Spray Cleaner 744 and Preposit Etch 748. Those within the industry are well versed in these formulations.

Following the pre-clean, the core proceeds to the imaging process. This is defined by two steps: application of the photoresist onto the core, and exposure to define a circuit pattern.

There are two types of photoresist that can be used, a positive acting resist and a negative acting photoresist. A positive resist will become more soluble in the exposed regions and a negative based resist will become less soluble. These resists are available as a dry film or liquid resist. Photoresist formulations include a binder polymer, a photopolymerizable compound, a photoinitiator, and a dye to provide contrast. Typical compositions for a dry film photoresist can be found in U.S. Pat. Nos. 6,329,123 and 6,166,245, each of which is incorporated by reference in its entirety.

Dry film photoresists are applied with a hot roll cut sheet laminator where as a liquid photoresist may be applied with a curtain or roller coater. The photoimageable material is applied to the copper surface of the core via one of these methods. If a dry film is used a polyethylene protective layer is removed prior to lamination to the copper surface. Once applied, the photoimageable resist is exposed to actinic radiation through the appropriate artwork. Exposure to the radiation polymerizes the monomer in the light exposed areas. This cross links the structure and makes it chemically resistant to the developer solution. The contrast between exposed and unexposed regions defines the circuit pattern. Once exposure is completed, the support film is removed from the exposed photoresist and the core is ready for processing through the developer solution.

A developer solution dissolves and washes away the exposed areas of resist. If a negative photoresist was used, the developer removes the unexposed areas. In either case, a circuitry pattern is revealed on the copper foil surface. The developer can be composed of potassium or sodium carbonate dissolved in water, typically at a concentration of 9-12 grams per liter or a 1-2%. It can also include small amounts of sodium hydroxide and EDTA, to maintain a proper pH and chelation. Periodic additions of an antifoaming agent may also be made to the developer chamber. An antifoam agent can include an organic siloxane or soybean oil surfactants, or an alcohol for solubility, such as octyldodecanol. The developer solution described can be used in both the development of inner-layer cores and as an outer-layer developer for the final circuit board.

After development, the exposed copper is etched with a solution of ammoniacal etchant or cupric chloride to expose the dielectric. This produces a three dimensional circuit pattern.

The final step in manufacturing the inner-layer core, called resist stripping, is the removal of the crosslinked photoresist. In this step, similar to development, a high concentration of a caustic agent can be used. The caustic agent reacts with the acidic monomers in the photoresist formulation thus neutralizing and removing the photoresist. Not all of the components are soluble, so some are dispersed into the bulk of the solution. The resist stripping solutions typically contain monoethanolamine and choline hydroxide as the main components. They can also include tetramethylammonium hydroxide, methyl alcohol, or potassium hydroxide. Typical strippers are include Enthone PC 4052 or Shipley Surfacestrip 446. An antifoam agent similar to the one described above can also be added to the resist stripping solution, for example Enthone DF 1207 or DF 2750. A solution of similar composition can be used to strip photoresist from the multilayer board in the final phases of manufacturing.

Inner-layer cores and the final printed circuit board can be processed in horizontal or vertical developers. This can also be a batch process carried out in tanks. More frequently, however, the fine features on the inner-layer core and the final printed circuit board require the use of sophisticated equipment to transport the thin material and prevent handling damage due to human intervention. Machines in use today typically include a variety of transport systems, pumps, spray manifolds, drive shafts, gears, spray nozzles and filtration devices to handle a variety of core and panel thicknesses.

The pumps and the spray manifold play important roles in delivering chemistry (such as developer and resist stripper) to the substrate surface. Typically, there are several pumps attached to the many spray bars to achieve adequate pressure. The nozzles along each bar are placed equidistant from each other and alternate on each spray bar to achieve the desired overlap spray pattern. Thus, the nozzles are arranged such that the entire surface of the core or board is impacted by the spray as it is transported through the machine. It can be important for the spray to contact all areas of the core or board.

The nozzles can form a spray pattern. The nozzles can be fan or cone shaped, depending on the application of chemistry and the desired output. The output is the spray pattern that effectively produces the desired result i.e. soldermask nozzles require high impingement to remove the soldermask from within the hole thus they typically use a cone nozzle that produces high pressure droplets. The number of nozzles can vary from 5-10 per spray bar with a total of 200-800 per chamber.

### SUMMARY

In general, a composition for use in printed circuit board manufacturing systems includes an oxidant. The composition can be used to clean equipment (e.g. nozzles, spray manifolds, drive shafts, roller wheels, gears, and any other equipment that comes into contact with the developer and/or resist stripper solutions) or strip photoresist from a substrate. The composition can be environmentally benign, that is, it can be substantially free of organic solvents. In particular, the oxidant can oxidize and dissolve residue that can clog nozzles in the system.

In one aspect, a method of maintaining printed circuit board manufacturing equipment includes contacting a component of the equipment with a composition including an oxidant. In another aspect, a method of cleaning printed circuit board manufacturing equipment includes contacting a component of the equipment including a residue with an aqueous solution including an oxidant to oxidize the residue.

The oxidant includes a compound that selectively oxidizes the photoresist or a residue produced by the photoresist development or stripping process more rapidly than other materials included on a printed circuit board. The oxidant can be a mild oxidant, which is capable of oxidizing the photoresist preferentially over a metallized component of a printed circuit board. The oxidant can include a peroxide, a peroxyacid, a hydroperoxide, or a perborate.

The composition can be an aqueous solution. The composition can include a pH modifier. The pH modifier can include a carbonate salt. The component can include a residue. The residue can include a resist, a soldermask, an antifoam agent, or a hard water deposit. The method can include oxidizing the residue. The method can include dispersing the residue. The method can include dissolving the residue. The component can include a nozzle. The method can include passing the composition through the nozzle. The component can include a second nozzle. The method can include passing the solution through the first nozzle and the second nozzle simultaneously. The pH modifier can be an acid or a base. The pH modifier can include sodium carbonate. The pH modifier can include acetic acid. The method can include maintaining the composition at a temperature greater than 80° F. The oxidant can include hydrogen peroxide. The oxidant can include sodium perborate. The oxidant can include an organic peroxide, a peracid, or a hydroperoxide. The solution can include a surfactant that is not oxidized by the oxidant. The method can include removing a waste material from the equipment, the waste material including water, an oxidant, and an oxidized resist.

In another aspect, a method of manufacturing a printed circuit includes contacting a board including a resist with a composition comprising an oxidant. The method can include oxidizing the resist. The resist can be overplated. Contacting the board with the composition can include spraying the composition on the board. Contacting the board with the composition can include immersing the board in the composition. The composition can include a pH modifier. The pH modifier can be an acid or a base. The pH modifier can include sodium carbonate. The oxidant can include hydrogen peroxide. The oxidant can include sodium perborate. The oxidant can include an organic peroxide, a peracid, or a hydroperoxide. The solution can include a surfactant that is not oxidized by the oxidant. The method can include maintaining the composition at a temperature greater than 80° F. The method can include removing a waste material from the equipment, the waste material including water, an oxidant, and an oxidized resist.

In another aspect, a composition for treating a printed circuit board resist includes an aqueous solution of an oxidant. In another aspect, a composition for treating a printed circuit board resist includes an aqueous solution of hydrogen peroxide and acetic acid. In another aspect, a composition for treating a printed circuit board resist can consist essentially of an aqueous solution of an oxidant and a pH modifier. In yet another aspect, a composition for treating a printed circuit board resist can consist essentially of an aqueous solution of hydrogen peroxide and a carbonate salt.

The composition can include a pH modifier. The pH modifier can be a carbonate salt. The concentration of the carbonate salt can be between 20 grams per liter and 200 grams per liter. The composition can include an organic peroxide, a peracid, or a hydroperoxide. The composition can include a surfactant that is not oxidized by the oxidant. The oxidant can be hydrogen peroxide. The concentration of hydrogen peroxide can be between 2.0% and 10% by volume. The concentration of hydrogen peroxide can be between 3% and 6% by volume and the concentration of sodium carbonate can be between 40 grams per liter and 100 grams per liter. The concentration of acetic acid can be between 1% and 10% by volume. The concentration of hydrogen peroxide can be between 3% and 6% by volume and the concentration of acetic acid can be between 3% and 6% by volume.

Several practices can limit or remove the precipitate of insoluble resist from a part or component of printed circuit board manufacturing equipment. Solution filtration is one common practice but it is not adequate in most cases to remove all particulates. A multiple element filtration system can be installed but at the cost of pressure losses in the spray manifolds. The finer cartridges used to remove particulate can compromise spray pressure in the developer and stripper chambers, which can reduce the efficiency of the system. A second practice is periodic chemical preventative maintenance. This usually involves the use of generic, commodity-based solutions to remove sludge formation, clogged nozzles and resist from the machine. Multiple solutions are used for a period of 2-4 hours followed by an associated rinse after each step. A chemical maintenance process can involve a caustic wash with 10% NaOH, a rinse, an acid rinse with 10% H₂SO₄, and a final rinse. Most of the standard cleaning solutions can be left at elevated temperatures for 3-4 hours. Not all of the components within the developed or stripped photoresist and photoimageable soldermask can be dissolved by this process.

Solvents can also be used to remove resist. Solvents in use have limited ability to solublize all components of the resist. A solvent system is selected to match the solubility of the various chemical components in the resist. Exemplary solvents are butyl carbitol and N-methyl pyrrolidone. Solvents also have limited use. N-Methyl pyrrolidone, for example, cannot be used on all types of equipment as it can damage poly(vinyl chloride)pipes, nozzles, chambers, and transport gears. This limits the use of N-methyl pyrrolidone to stainless steel equipment. Solvent based systems also require consideration of environmental and waste treatment issues.

Finally, traditional procedures require time-consuming manual cleaning, which requires removing, cleaning, and replacing each of the 200-800 nozzles per chamber. An example of a cleaning solution, including carbonate salts and surfactants, is described in U.S. Pat. No. 5,575,857, which is incorporated by reference in its entirety.

A composition including an oxidant can oxidize a residue including a resist, an antifoam agent, a hard water deposit, or a combination of these. Once oxidized, the residue can become water dispersible or water soluble. The compositions can be used to remove otherwise insoluble resist residue from equipment, to strip resist during the manufacture of a printed circuit board, or both. Equipment can be cleaned in place, that is, no disassembly of equipment is needed for cleaning.

The details of one or more embodiments are set forth in the accompanying drawings and the description below. Other features, objects, and advantages will be apparent from the description and from the claims.

### DETAILED DESCRIPTION

Insoluble components in the photoresist formulations can precipitate onto the various parts of printed circuit board manufacturing equipment. Of particular concern in the manufacturing process is the continual build up of residue inside the many nozzle orifices. Reduction in the nozzle orifice reduces the flow of solution (e.g., developer solution or resist stripping solution) to the work piece, producing areas of under-development and inadequate removal of resist or soldermask. The nozzles can become completely clogged, preventing the flow of solution. “Dead areas” can form where solution does not reach the substrate surface. Precipitation and clogging are further aggravated by the use of an antifoam agent. While antifoam agents can be useful to reduce foam, they are not soluble in the developer or resist stripper and contribute to clogged nozzles.

A formulation including an oxidant can oxidize any of the organics or scale build up that occurs in the manufacturing of printed circuit boards, also called residue. Residue can include components of resist, hard water deposits, flux residues from the hot air solder leveling process, or hot oil reflow. Hot oil reflow produces a eutectic tin/lead deposit from electroplated tin/lead. The electroplated deposit is immersed in a preheat oil to bring the metal to temperature, then placed in a second oil at a higher temperature which allows the metals to flow. This produces a eutectic finish that is ready for soldering of components at the assembly level. The organic oils must be removed from the surface of the deposit after reflow. The formulation can remove reflow oils from a substrate. The formulations can be used as a replacement for solvents used in screen cleaning. Resist chips from step wedges or artwork irregularities can be oxidized into a soluble form. A single formulation can be used to clean innerlayer and outerlayer developers and resist strippers as well as soldermask developers.

Organic and inorganic oxidants can oxidize resist and resist residues, thereby rendering them soluble in a mild solvent. The mild solvent can be a non-organic solvent, such as water, that does not degrade poly(vinyl chloride). A mild water-based solvent can have a pH between 2 and 12. The oxidant can be dissolved in an aqueous solution. An aqueous solution is a water-containing solution. Water can be the only solvent in the aqueous solution. All components of the resist can be oxidized and made water soluble. The oxidant can be a peroxide. These formulations include an oxidizer and an organic or inorganic chemical. The organic or inorganic chemical can alter the pH of an aqueous solution, that is, the chemical can be an acid or a base. Upon contacting the precipitate, the oxidizer breaks the associated bonds and solublizes the photoresist and/or antifoam agent. Several exemplary formulations are listed in Table 1.

TABLE 1
Formulations

| Formulation # | Component | Concentration in H₂O |
|---|---|---|
| 1 | Na₂CO₃ | 60 g/L |
| | H₂O₂ | 5% by volume |
| | | (of a 35 weight percent aqueous stock |
| | | solution) |
| 2 | NaBO₃.4H₂O | 60 g/L |
| 3 | CH₃COOH | 5% by volume |
| | | (of a 99% stock solution) |
| | H₂O₂ | 5% by volume |
| | | (of a 35 weight percent aqueous stock |
| | | solution) |

The concentration of the oxidant in the formulation can vary. The concentration of hydrogen peroxide can be in the range of 2.0% to 10% by volume of 35 weight percent H₂O₂, for example in the range of 2.5 to 5%, 4 to 6%, 6 to 8%, 5 to 10%, or 7.5 to 10%. Higher concentrations of peroxide may also be used, such as 50 weight percent or 75 weight percent hydrogen peroxide. A non-oxidizable surfactant, which is a surfactant that resists oxidation by the formulation, such as, for example a Fluorad from 3M, can be included to improve wetting of the various surfaces. The reaction is exothermic, so the temperature can be adjusted according to the amount of material to be oxidized. The temperature can be in the range of 50 to 200° F., or in the range of 80 to 140° F. The concentration of sodium carbonate can be in the range of 40 to 120 g/L. The concentration range for sodium perborate can be 40 to 100 g/L. The acetic acid concentration can be between 2.5% and 15% by volume of a 99% glacial acetic acid solution.

The oxidant can be an inorganic oxidant or an organic oxidant. Examples of inorganic oxidants include sodium percarbonate, sodium perborate tetrahydrate, sodium peroxide, calcium peroxide, magnesium peroxide, or sodium perborate monohydrate. Examples of organic oxidants include peroxyacetic acid, peroxyformic acid, dibenzoyl peroxide, succinic acid peroxide, dilauroyl peroxide, didecanoyl peroxide, m-chloroperoxybenzoic acid, t-butyl hydroxperoxide, di(n-propyl)peroxydicarbonate, di(sec-butyl) peroxydicarbonate, or di-(2-ethylhexyl)-peroxydicarbonate.

The formulations can oxidize the components of photoresist and/or antifoam agent that clog nozzles and deposit on equipment surfaces, such as heating and cooling coils, transport wheels, and gears. While not wishing to be bound by theory, oxidation can break the chemical bonds that form the various precipitates and sludge on the equipment. All of the various components in resist and antifoam formulations can be dissolved by this process. Oxidation is critical to dissolving the material effectively. For example, a formulation can oxidize the deposits within a clogged nozzle, breaking down the deposits into smaller and smaller particles until the particles pass through the nozzle orifice. The particles can then be either filtered out or allowed to continue dissolving until washed away in a soluble form.

Nozzles can be cleaned without being removed from the equipment. For example, a cleaning solution including an oxidant can be passed through nozzles in the same manner as the developer or resist stripper solution is during normal operation of the equipment. The oxidant ensures that the precipitates and particulates are solublized or dispersed in the cleaning process. Oxidation can be non-selective, that is the oxidant can oxidize all of the organic material it contacts. This can solve the problem of selective removal of the precipitate, and can eliminate the need for labor-intensive preventative maintenance that may be inefficient or inadequate in removing 100% of the precipitation.

As discussed above, for most chemical preventative maintenance schedules, multiple chemicals are used for a period of 2-4 hours, and each is followed by a rinse. Oxidizing formulations allow cleaning to be reduced to two steps: a chemical step and a rinse step. The oxidation reaction is completed within 30-60 minutes, reducing the down time and the use of materials and rinse water compared to other processes. These formulations will also solublize the scale build up due to calcium and/or magnesium deposits that result from hard water. A secondary acid step to remove hard water deposits is not needed.

The formulations can also be used to clean equipment used for the development of soldermask. Soldermasks are protective coatings used to insulate the board during component insertion at the assembly level. A typical composition for a soldermask can be found in U.S. Pat. Nos. 4,693,961, 6,180,317, or 6,210,862, each of which is incorporated by reference in its entirety. For example, a soldermask can contain a low molecular weight epoxy containing epoxy resin, a high-molecular weight epoxy resin based on polyol resin, a light sensitive ethylenically unsaturated monomer, and a photoinitiator and/or sensitizer.

The residue that forms within the soldermask equipment is the same in terms of precipitation, sludge formation, etc. The residue can be composed of the soldermask, developer, antifoam agents and hard water deposits. The formulations are capable of removing this residue from, for example, clogged nozzles through the oxidation of the various components of the residue. In particular this prevents the associated downtime and inefficiency associated with the manual labor of removing cleaning and replacing the nozzles. The formulations can contain a small amount of a additive to increase solubility and/or dispersability of the residue, for example alkylene carbonates such as ethylene carbonate and propylene carbonate.

The process of resist stripping is similar to development. The degree of crosslinking and the acid number of the binder polymer dictate how easily the photoresist is stripped. An alkaline stripper is sprayed on the board. The alkaline components, commonly including monoethanolamine and choline hydroxide, react with the carboxylic acid groups in the binder polymer that are bound to the copper surface. A smaller amount of choline hydroxide (1-5%) than monoethanolamine (30-40%) is used, due to its high cost. Choline hydroxide reacts very quickly and is consumed early on. The photoresist is not dissolved but rather breaks into pieces or chips as the base penetrates the resist and reacts at the copper-resist interface. The chips are dislodged from the surface of the board by the force of the spray. The photoresist chips are filtered from the solution by a rotating drum filter to prevent consumption of the chemistry. If the spacing between the conductive traces is too small, the spray manifold may be unable to remove the chip. As the spacing between the conductive traces is reduced the ability of the spray manifold, nozzles, pressure of solution, spray pattern etc. becomes critical to removing the photoresist.

Overplating of resist can occur in the outer-layer construction of a printed circuit board. During the electroplating of a circuit board, the copper circuits that are defined by the photoresist can be overplated with copper, tin, or tin/lead. If the overplated metal extends over the top of the photoresist as well, an undesirable condition of resist lock-in results. Removing overplated resist with the existing methods is extremely difficult, because the overplated resist is effectively trapped. Spraying solutions of resist stripper cannot dislodge any resist that is trapped by this method without using extreme measures that is not always effective.

An oxidizing formulation can be used to strip photoimageable resist. An oxidant can react with all the components in the resist. Oxidized resist can be water soluble. Because the oxidized resist dissolves, a spray manifold is not required to dislodge fragments of resist. The formulations can dissolve photoresist even if it has been overplated. In addition, oxidizing and dissolving the resist can prevent undesirable re-deposition of partially polymerized resist. Re-deposition is undesirable because it can cause opens or shorts depending on the application.

### EXAMPLE 1

A spray nozzle, clogged with developer/antifoam residue, was removed from an innerlayer developer machine. The scale residue was quite heavy on all areas of the nozzle. The nozzle was washed in formulation 1 (see Table 1) for 6 minutes at 120-130° F., then rinsed with water. After washing, 95% of all the residue was removed from the nozzle. The nozzle was no longer clogged and solution flowed freely through the nozzle orifice.

### EXAMPLE 2

A spray nozzle exhibiting significant scale and incapable of passing developer solution was washed in formulation 2 (see Table 1) at 125° F. The scale was the residue from a developer solution containing Shipley Company Photoresist 1430, Shipley Company Antifoam 2750 and a proprietary developer solution of sodium carbonate at 6.0-12.0 g/L. After 5 minutes, the part was inspected and rinsed. Hydrogen peroxide was added to the wash at a final concentration of 1.0% by volume, and the part was washed for a further 6 minutes at 125° F. The developer residue was removed from the part. The part was clean and solution flowed freely through the nozzle.

### EXAMPLE 3

A spray nozzle exhibiting significant residue and incapable of passing soldermask developer solution through the orifice nozzle was washed in formulation 1 (see Table 1) at 125 -135° F. for 15 minutes. The material within the nozzle was the result of the developer residue associated with antifoam agent 2750 from Shipley Co., calcium/magnesium hard water deposits, and soldermask from Taiyo, PSR-4000 BN(HV). The nozzle was washed in formulation 1 (see Table 1) at 125-135° F. for 15 minutes. The reaction was exothermic, causing the temperature to increase to 138° F. The part was rinsed for 1 minute at 50-60 ° F. After 15 minutes the nozzle exterior was clean. A small amount of residue was left on the inside of the nozzle that would be removed when under pressure and the solution is moving. A filter removes loosened particles from the wash. Solution then flowed freely through the nozzle orifice.

### EXAMPLE 4

To test an oxidizing formulation for use as a resist stripper, a printed circuit board that had been laminated with Shipley LB004 photoresist, exposed and developed, then pattern plated with copper and tin/lead was examined. The board was treated with formulation 1 (see Table 1) for 3.5 minutes at 133° F. During this time the photoresist was oxidized and began to dissolve into the solution after 2 minutes. The board was then rinsed for 30 seconds at 60-70° F.

A number of embodiments have been described. Nevertheless, it will be understood that various modifications may be made. Accordingly, other embodiments are within the scope of the following claims.

What is claimed is:

1. A method of maintaining printed circuit board manufacturing equipment comprising contacting a component of the equipment with a composition including an oxidant.

2. The method of claim 1, wherein the composition is an aqueous solution.

3. The method of claim 1, wherein the oxidant includes a peroxide.

4. The method of claim 1, wherein the composition further comprises a pH modifier.

5. The method of claim 4, wherein the pH modifier includes a carbonate salt.

6. The method of claim 4, wherein the pH modifier is an acid.

7. The method of claim 4, wherein the pH modifier is a base.

8. The method of claim 4, wherein the pH modifier includes sodium carbonate.

9. The method of claim 4, wherein the pH modifier includes acetic acid.

10. The method of claim 1, wherein the component includes a residue.

11. The method of claim 10, wherein the residue includes a resist, a soldermask, an antifoam agent, or a hard water deposit.

12. The method of claim 10, further comprising oxidizing the residue.

13. The method of claim 10, further comprising dispersing the residue.

14. The method of claim 10, further comprising dissolving the residue.

15. The method of claim 1, wherein the component includes a nozzle.

16. The method of claim 15, further comprising passing the composition through the nozzle.

17. The method of claim 15, wherein the component includes a second nozzle.

18. The method of claim 17, further comprising passing the solution through the first nozzle and the second nozzle simultaneously.

19. The method of claim 1, wherein contacting includes maintaining the composition at a temperature greater than 80° F.

20. The method of claim 1, wherein the oxidant includes hydrogen peroxide.

21. The method of claim 1, wherein the oxidant includes sodium perborate.

22. The method of claim 1, wherein the oxidant includes an organic peroxide, a peracid, or a hydroperoxide.

23. The method of claim 1, wherein the solution includes a surfactant that is not oxidized by the oxidant.

24. The method of claim 1, further comprising removing a waste material from the equipment, the waste material including water, an oxidant, and an oxidized resist.

25. A method of cleaning printed circuit board manufacturing equipment comprising contacting a component of the equipment including a residue with an aqueous composition including an oxidant to oxidize the residue.

26. The method of claim 25, wherein the residue includes a resist, a soldermask, an antifoam agent, or a hard water deposit.

27. The method of claim 25, further comprising dispersing the residue.

28. The method of claim 25, further comprising dissolving the residue.

29. The method of claim 25, wherein the component includes a nozzle.

30. The method of claim 25, wherein the oxidant includes hydrogen peroxide.

31. The method of claim 25, wherein the aqueous composition includes sodium carbonate.

32. The method of claim 25, wherein the aqueous composition includes acetic acid.

33. The method of claim 25, wherein the oxidant includes an organic peroxide, a peracid, or a hydroperoxide.

34. The method of claim 25, further comprising removing a waste material from the equipment, the waste material including water, an oxidant, and an oxidized resist.

35. A method of manufacturing a printed circuit comprising contacting a board including a resist with a composition comprising an oxidant.

36. The method of claim 35, further comprising oxidizing the resist.

37. The method of claim 35, wherein the resist is overplated.

38. The method of claim 35, wherein contacting the board with the composition includes spraying the composition on the board.

39. The method of claim 35, wherein contacting the board with the composition includes immersing the board in the composition.

40. The method of claim 35, wherein the composition includes a pH modifier.

41. The method of claim 40, wherein the pH modifier is an acid.

42. The method of claim 40, wherein the pH modifier is a base.

43. The method of claim 40, wherein the pH modifier includes sodium carbonate.

44. The method of claim 40, wherein the pH modifier includes sodium carbonate and the oxidant include hydrogen peroxide.

45. The method of claim 35, further comprising maintaining the composition at a temperature greater than 80° F.

46. The method of claim 35, wherein the oxidant includes hydrogen peroxide.

47. The method of claim 35, wherein the oxidant includes sodium perborate.

48. The method of claim 35, wherein the oxidant includes an organic peroxide, a peracid, or a hydroperoxide.

49. The method of claim 35, further comprising removing a waste material from the equipment, the waste material including water, an oxidant, and an oxidized resist.

50. A composition for treating a printed circuit board resist comprising an aqueous solution of an oxidant.

51. The composition of claim 50, further comprising a pH modifier.

52. The composition of claim 51, wherein the pH modifier is a carbonate salt.

53. The composition of claim 52, wherein the concentration of the carbonate salt is between 20 grams per liter and 200 grams per liter.

54. The composition of claim 50, wherein the oxidant includes an organic peroxide, a peracid, or a hydroperoxide.

55. The composition of claim 50, further comprising a surfactant that is not oxidized by the oxidant.

56. The composition of claim 50, wherein the oxidant is hydrogen peroxide.

57. The composition of claim 56, wherein the concentration of hydrogen peroxide is between 2.0% and 10% by volume.

58. The composition of claim 56, further comprising a pH modifier.

59. The composition of claim 58, wherein the pH modifier is a carbonate salt

60. The composition of claim 59, wherein the concentration of hydrogen peroxide is between 2.0% and 10% by volume and the concentration of the carbonate salt is between 20 grams per liter and 200 grams per liter.

61. The composition of claim 59, wherein the concentration of hydrogen peroxide is between 3% and 6% by volume and the concentration of sodium carbonate is between 40 grams per liter and 100 grams per liter.

62. A composition for treating a printed circuit board resist comprising an aqueous solution of hydrogen peroxide and acetic acid.

63. The composition of claim 62, wherein the concentration of hydrogen peroxide is between 2.0% and 10% by volume.

64. The composition of claim 62, wherein the concentration of acetic acid is between 1% and 10% by volume.

65. The composition of claim 62, wherein the concentration of hydrogen peroxide is between 2.0% and 10% by volume and the concentration of acetic acid is between 1% and 10% by volume.

66. The composition of claim 62, wherein the concentration of hydrogen peroxide is between 3% and 6% by volume and the concentration of acetic acid is between 3% and 6% by volume.

67. A composition for treating a printed circuit board resist consisting essentially of an aqueous solution of an oxidant and a pH modifier.

68. A composition for treating a printed circuit board resist consisting essentially of an aqueous solution of hydrogen peroxide and a carbonate salt.
